(19) United States
(12) Patent Application Publication
(10) Pub. No.: US 2024/0281241 A1
(43) Pub. Date: Aug. 22, 2024

(54) WRITE CONTROL DEVICE, UPDATE CONTROL DEVICE, ELECTRONIC CONTROL SYSTEM, SOFTWARE UPDATE CONTROL METHOD, AND STORAGE MEDIUM STORING SOFTWARE UPDATE CONTROL PROGRAM

(71) Applicant: DENSO CORPORATION, Kariya-city (JP)

(72) Inventors: Reiichiro IMOTO, Kariya-city (JP); Yasuharu SUGANO, Kariya-city (JP); Takeshi NAKAMURA, Kariya-city (JP)

(21) Appl. No.: 18/444,812

(22) Filed: Feb. 19, 2024

(30) Foreign Application Priority Data
Feb. 21, 2023 (JP) 2023-025556

(51) Int. Cl. G06F 8/65; H04L 9/40

(52) U.S. Cl. CPC G06F 8/65; H04L 63/126

(57) ABSTRACT

An update control device is configured to obtain an update file for updating a software and a signature from a distribution device, transmit the update file to a device to be updated, determine a verification device verifying the signature from electronic control units on a basis of a scheme of the signature, and transmit the signature and a verification instruction instructing verification of the signature to the verification device.

### CROSS REFERENCE TO RELATED APPLICATION

This application is based on Japanese Patent Application No. 2023-025556 filed on Feb. 21, 2023, the disclosure of which is incorporated herein by reference.

### TECHNICAL FIELD

The present disclosure relates mainly to an update control device as a device controlling updating of software mounted in an in-vehicle electronic control system, the electronic control system, a method realized by the devices, and a program which can be executed by the devices.

### BACKGROUND

A related art discloses a technique that first and second devices are mounted in a vehicle, a signature using a post-quantum algorism attached to update information for the second device is verified by the first device, when the update information is regarded as valid, the update information is relayed to the second device, and the second device updates a software component in the second device by using the update information.

### SUMMARY

An update control device is configured to obtain an update file for updating a software and a signature from a distribution device, transmit the update file to a device to be updated, determine a verification device verifying the signature from electronic control units on a basis of a scheme of the signature, and transmit the signature and a verification instruction instructing verification of the signature to the verification device.

### BRIEF DESCRIPTION OF THE DRAWINGS

Objects, features and advantages of the present disclosure will become more apparent from the following detailed description made with reference to the accompanying drawings. In the drawings:

FIG. 1A is a diagram illustrating disposition of an update control device;

FIG. 1B is a diagram illustrating disposition of an update control device;

FIG. 1C is a diagram illustrating disposition of an update control device;

FIG. 2 is a diagram illustrating an example of the configuration of an electronic control system;

FIG. 3 is a block diagram illustrating the configuration of an update control device of the first embodiment;

FIG. 4 is an explanatory diagram illustrating a verification possibility information management table used by the update control device of the first embodiment;

FIG. 5 is an explanatory diagram illustrating a method of determining a verification device in the update control device of the first embodiment;

FIG. 6 is a block diagram illustrating the configuration of a device to be updated of the first embodiment;

FIG. 7 is a diagram illustrating operation of the update control device of the first embodiment;

FIG. 8 is a block diagram illustrating the configuration of an update control device of a modification of the first embodiment;

FIG. 9 is an explanatory diagram illustrating a storage unit information management table used by the update control device of a modification of the first embodiment;

FIG. 10 is a diagram illustrating operation of an update control device of a modification the first embodiment;

FIG. 11 is a block diagram illustrating the configuration of an update control device of a second embodiment;

FIG. 12 is a block diagram illustrating the configuration of a device to be updated of the second embodiment;

FIG. 13 is a diagram illustrating operation of an update control device of the second embodiment;

FIG. 14 is a block diagram illustrating the configuration of a device to be updated of a modification of the second embodiment;

FIG. 15 is a diagram illustrating operation of an update control device of a modification the second embodiment;

FIG. 16 is a block diagram illustrating the configuration of a write control device of a third embodiment;

FIG. 17 is a block diagram illustrating the configuration of a device to be written of the third embodiment; and

FIG. 18 is a block diagram illustrating operation of a write control device of the third embodiment.

### DETAILED DESCRIPTION

In a vehicle, various electronic control units connected by an in-vehicle network are mounted. Since functions requested for a vehicle are becoming complicated with development of the autonomous driving technology in recent years, the number of electronic control units mounted in a vehicle is increasing.

Software of electronic control units has to be updated for the purposes of increasing security performance by eliminating vulnerability, adding a new function, and improving an existing function. An update file for updating software can be received, for example, from a distribution device via a communication line.

In the case of receiving an update file from a distribution device, it may be desirable to transmit an update file with a signature for the purposes of confirmation of authenticity of the update file, authentication, and non-repudiation. For example, a related art discloses a technique that first and second devices are mounted in a vehicle, a signature using a post-quantum algorism attached to update information for the second device is verified by the first device, when the update information is regarded as valid, the update information is relayed to the second device, and the second device updates a software component in the second device by using the update information.

As a result of close examination, the inventors of the present disclosure found out the following problems. In preparation for the crisis of existing cryptographies, there is the possibility that migration to post-quantum cryptography will be made in future. In this case, it is assumed that the post-quantum cryptography requires a device to have higher processing performance as compared with the existing cryptographies. Since the key data length of the post-quantum cryptography is long, it is also assumed that a sufficient storage area is necessary. Since it is assumed that considerably long time is required for all of a plurality of electronic control units constructing an electronic control system to be ready for post-quantum cryptography, there is the possibility that realization of an electronic control system which is ready for the post-quantum cryptography delays. In the case of performing verification by a first device as in the related art, the load on the first device increases.

The present disclosure provides a technique to realize a write control device, an update control device, and the like which can properly assign verification of a signature to a device capable of verifying a signature in the case where there is a device incapable of verifying a signature.

According to one aspect of the present disclosure, an update control device controlling updating of software of a device to be updated as a software update target among a plurality of electronic control units which are connected to the update control device is provided. The update control device comprises: an update file transfer unit that is configured to obtain an update file for updating the software and a signature generated from the update file from a distribution device, and transmit the update file to the device to be updated; a verification device determination unit that is configured to determine a verification device verifying the signature from the plurality of electronic control units on a basis of a scheme of the signature; and a verification instruction unit that is configured to transmit the signature and a verification instruction instructing verification of the signature to the verification device.

According to another aspect of the present disclosure, an electronic control system is provided. The electronic control system comprises: an update control device controlling updating of software of a device to be updated as a software update target among a plurality of electronic control units which are connected; and the plurality of electronic control units. The update control device comprises: an update file transfer unit obtaining an update file for updating the software and a signature generated from the update file from a distribution device, and transmitting the update file to the device to be updated; a verification device determination unit determining a verification device verifying the signature from the plurality of electronic control units on a basis of a scheme of the signature; and a verification instruction unit transmitting the signature and a verification instruction instructing verification of the signature to the verification device. The device to be updated comprises: an update file reception unit receiving the update file from the update control device; a verification result reception unit receiving a verification result of the signature from the verification device or the update control device; and a software update unit updating software by using the update file on a basis of the verification result.

According to another aspect of the present disclosure, a write control device controlling writing of information to a device to be written as an object to which information is to be written among a plurality of electronic control units which are connected is provided. The write control device comprises: a file transfer unit obtaining a file for writing the information and a signature generated from the file from a distribution device, and transmitting the file to the device to be written; a verification device determination unit determining a verification device verifying the signature from the plurality of electronic control units on a basis of the scheme of the signature; and a verification instruction unit transmitting the signature and a verification instruction instructing verification of the signature to the verification device.

According to another aspect of the present disclosure, a software update control method executed by an update control device controlling updating of software in a device to be updated as a software update target among a plurality of electronic control units which are connected is provided. The software update control method comprises: obtaining an update file for updating the software and a signature generated from the update file from a distribution device, and transmitting the update file to the device to be updated; determining a verification device verifying the signature from the plurality of electronic control units on a basis of the scheme of the signature; and transmitting the signature and a verification instruction instructing verification of the signature to the verification device.

According to another aspect of the present disclosure, a non-transitory computer-readable storage medium storing a software update control program which can be executed by an update control device controlling updating of software of a device to be updated as a software update target among a plurality of electronic control units which are connected is provided. The software update control program comprises obtaining an update file for updating the software and a signature generated from the update file from a distribution device, and transmitting the update file to the device to be updated; determining a verification device verifying the signature from the plurality of electronic control units on a basis of the scheme of the signature; and transmitting the signature and a verification instruction instructing verification of the signature to the verification device.

With the above configuration, the write control device, the update control device, and the like of the present disclosure determine a verification device verifying a signature and give a verification instruction to the verification device, so that signature verification can be assigned to a proper verification device.

Hereinafter, embodiments of the present disclosure will be described with reference to the drawings.

When there are a plurality of embodiments (including modifications), a configuration disclosed in any of the embodiments is not limited only to the embodiment, and configurations of embodiments can be combined. For example, a configuration disclosed in one embodiment may be combined with another embodiment. Configurations respectively disclosed in a plurality of embodiments may be collectively combined.

### CONFIGURATION AS PREMISE OF EMBODIMENTS

### (Configuration of Write Control Device or Update Control Device)

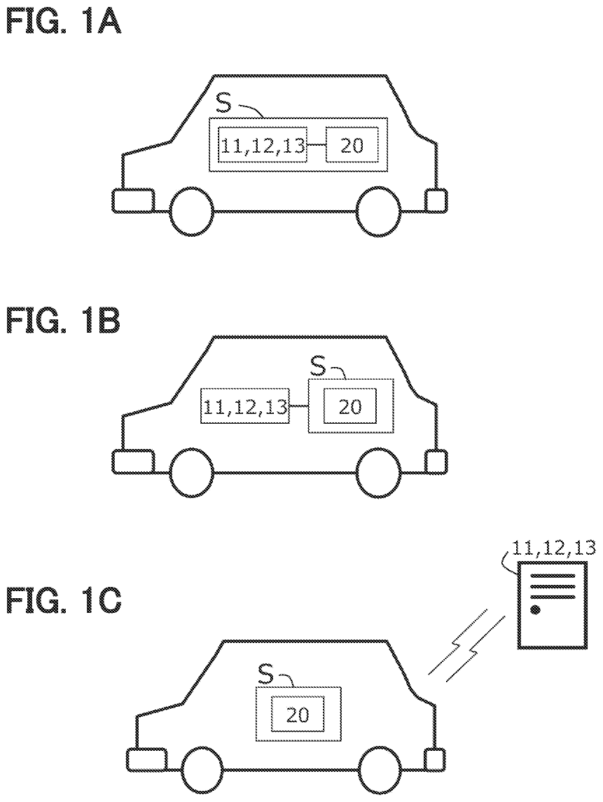

FIG. 1A, FIG. 1B, and FIG. 1C are diagrams illustrating disposition of a “write control device” or an “update control device” of each of embodiments. For example, there are assumed cases: a case where an update control device 11, an update control device 12, and a write control device 13 (hereinafter, called the update control device 11 and the like) are “mounted” in a vehicle as a “mobile object” together with an electronic control unit 20 as a component of an electronic control system S as illustrated in FIG. 1A and FIG. 1B; and a case where the electronic control unit 20 as a component of the electronic control system S is “mounted” in a vehicle as a “mobile object” and the update control device 11 and the like are realized by a server device or the like disposed on the outside of the vehicle as illustrated in FIG. 1C. Since a “write control device” is a device writing information such as software and data to an electronic control unit, it is a concept including an “update control device” that writes new software or new data so as to replace old software or old data to an electronic control unit. A “mobile object” may also be referred to as a movable object, and its moving speed is arbitrary. Obviously, the case that a mobile object is stationary is also included. For example, the mobile object includes a car, a motorcycle, a bicycle, a pedestrian, a ship, an aircraft, and an object mounted in any of them. However, the present disclosure is not limited to those objects. The state of being “mounted” includes not only the case of direct fixation to a mobile object but also the case of movement together with a mobile object without fixation to the mobile object. For example, the case where a person riding on a mobile object has an object and the case where an object is loaded in cargo mounted on a mobile object can be mentioned.

The update control devices 11 and 12 are devices controlling updating of “software” for one or plural “electronic control unit(s)” 20 (hereinafter, called ECU(s)) constructing the electronic control system S which is “connected” to the update control devices 11 and 12. Among the ECUs 20, particularly, the ECU 20 as an object to be subjected to software updating will be called a device to be updated. The write control device 13 is a device controlling writing of “information” to one or plural “electronic control unit(s)” 20 (hereinafter, called ECU(s)) constructing the electronic control system S which is “connected” to the write control device 13. Among the ECUs 20, particularly, the ECU 20 as an object to be subjected to software writing will be called a device to be written. The “connected” state refers to a state where data can be transmitted/received, and includes obviously the case where different hardware is connected via a wired or wireless communication network, and also the case where virtual machines realized on the same hardware are virtually connected. The “ECU” may be an electronic control unit which is physically independent or a virtual electronic control unit realized by using a virtualization technique. “Software” includes obviously software which operates on an OS (Operating System) and also middleware (for example, OS) operating an ECU itself. “Information” includes software or data. The software includes obviously software which operates on an OS (Operating System) and also middleware (for example, OS) operating an ECU itself. The data includes a moving image, a stationary image, a map, and the like.

In the case of FIG. 1A and FIG. 1B, the update control device 11 and the like and each of the ECUs 20 are “connected”, for example, via an in-vehicle communication network such as a CAN (Controller Area Network) or an LIN (Local Interconnect Network). Alternatively, they may be connected by using an arbitrary wired/wireless communication method such as Ethernet (registered trademark), Wi-Fi (registered trademark), or Bluetooth (registered trademark).

FIG. 1A illustrates that the update control device 11 and the like are provided on the inside of the electronic control system S or the functions of the update control device 11 and the like are provided for at least one of the ECUs 20 constructing the electronic control system S.

FIG. 1B illustrates that the update control device 11 and the like are provided on the outside of the electronic control system S but, from the viewpoint of the form of connection, a configuration of FIG. 1B is substantially the same as FIG. 1A.

FIG. 1C also illustrates that the update control device 11 and the like are provided on the outside of the electronic control system S. However, since the update control device 11 and the like are provided on the outside of the vehicle, the form of connection is different from that of FIG. 1A and that of FIG. 1B. The update control device 11 and the like and the electronic control system S are “connected”, for example, via a communication network of a wireless communication system such as IEEE802.11 (Wi-Fi (registered trademark)), IEEE802.16 (WiMAX (registered trademark)), W-CDMA (Wideband Code Division Multiple Access), HSPA (High Speed Packet Access), LTE (Long Term Evolution), LTE-A (Long Term Evolution Advanced), 4G, 5G, or the like. Alternatively, DSRC (Dedicated Short Range Communication) can be used. When a vehicle is parked in a parking lot or stays in a repair shop, a wired communication system can be used in place of a wireless communication system. For example, LAN (Local Area Network), Internet, or a fixed-telephone line can be used.

In the case of FIG. 1C, the update control device 11 and the like as server devices control updating and writing of software mounted in each of the ECUs 20 constructing the electronic control system S mounted in a vehicle from the outside of the vehicle.

### (Configuration of Electronic Control System S)

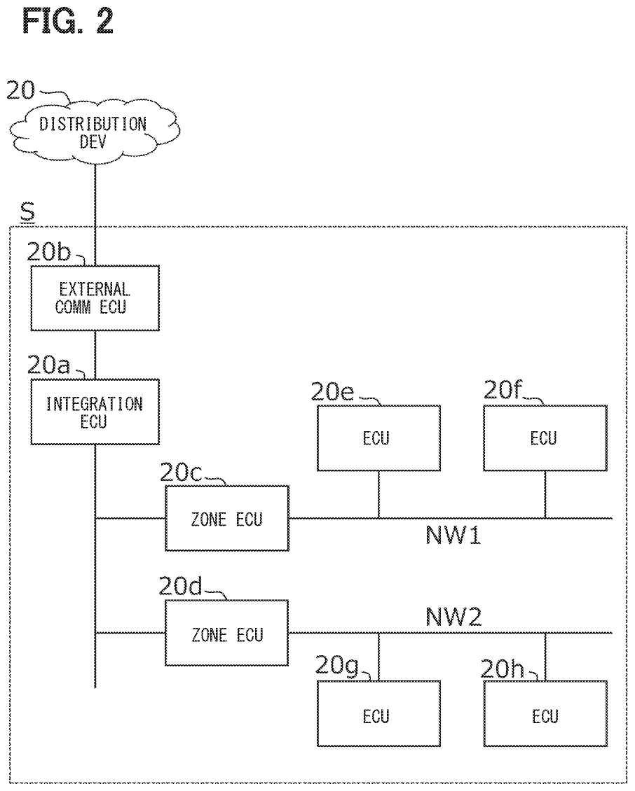

FIG. 2 is a diagram illustrating a configuration example of the electronic control system S. The electronic control system S is configured by a plurality of ECUs 20 and an in-vehicle network connecting them. Although FIG. 2 illustrates eight ECUs (ECUs 20a to 20h), as a matter of course, the electronic control system S is configured by arbitrary number of ECUs. Hereinafter, in the case of describing one or plural electronic control units inclusively, the ECUs will be described as the ECU 20 and each of the ECUs 20. In the case of specifying an individual ECU, it will be described as ECU 20a, ECU 20b, ECU 20c, or the like.

In the case of FIG. 2, the ECUs 20 are connected by the in-vehicle network, a wired communication system, or a wireless communication system described with reference to FIG. 1A and FIG. 1B. The connection refers to a state where data can be transmitted and received and includes, obviously, the case where different hardware is connected via a wired/wireless communication network and also the case where virtual ECUs (also called virtual machines) realized on the same hardware are virtually connected.

The electronic control system S illustrated in FIG. 2 includes an integration ECU 20a, an external communication ECU 20b, zone ECUs (20c and 20d), and individual ECUs (20e to 20h).

The integration ECU 20a is an ECU having a function of controlling the entire electronic control system S and a gateway function of intermediating communications among the ECUs 20. The integration ECU 20a is also called a gateway ECU (G-ECU) or a mobility computer (MC). The integration ECU 20a may be a relay device or a gateway device.

The external communication ECU 20b is an ECU having a communication unit performing communication with an external device provided on the outside of the vehicle, for example, a distribution device 30 in the embodiments. The communication system used by the external communication ECU 20b is the wireless communication system or the wired communication system in the description of FIG. 1C. To realize a plurality of communication systems, a plurality of external communication ECUs 20b may be provided. Instead of providing the external communication ECU 20b, the integration ECU 20a may include the function of the external communication ECU 20b.

The zone ECUs (20c and 20d) are ECUs having the gateway function and properly disposed in places where the individual ECUs are disposed or disposed according to functions. For example, the zone ECU 20c is an ECU having a gateway function of intermediating communication between the individual ECUs 20e and 20f disposed in the front part of the vehicle and the other ECUs 20. The zone ECU 20d is an ECU having a gateway function of intermediating communication between the individual ECUs 20g and 20h disposed in the rear part of the vehicle and the other ECUs 20. The zone ECUs (20c and 20d) are also called domain computers (DC). To the zone ECU 20c, the individual ECUs 20e and 20f are connected via a network 1 (NW1). To the zone ECU 20d, the individual ECUs 20g and 20h are connected via a network 2 (NW2).

As the individual ECU (20e to 20h), an ECU having an arbitrary function may be used. Examples include drive-system electronic control units controlling an engine, a steering wheel, a brake, and the like, vehicle-body-system electronic control units controlling meters, power windows, and the like, information-system electronic control units of a navigation device and the like, and safety-control-system electronic control units performing control to prevent collision with an obstacle and a pedestrian. The ECUs may not be in parallel but may be classified to a master and slaves.

In each of the embodiments, the case where the update control device 11 and the like are provided in the integration ECU 20a in the cases FIG. 1A will be described as an example. The update control device 11 and the like may be provided in the external communication ECU 20b, the zone ECUs (20c and 20d), or the individual ECUs (20e to 20h). In the case where the update control device 11 and the like are provided in one of the individual ECUs (20e to 20h), desirably, the individual ECU is a dedicated ECU realizing the update control device 11 and the like.

In the case where the ECU 20 which is not the external communication ECU 20b in the ECUs 20 constructing the electronic control system S has the function of the update control device 11 and the like, an update file transfer unit 101 and a file transfer unit 121 of the update control device 11 and the like which will be described later obtain an update file and a file from the outside of the electronic control system S via the external communication ECU 20b. In this case, the update control device 11 and the like in FIG. 1A are called a UCM master in the AUTOSAR (AUTomotive Open System ARchitecture) specification. The external communication ECU 20b is called an OTA (Over The Air) client in the AUTOSAR specification. Each of the ECUs 20 in FIG. 2 is called a UCM (Update and Configuration Management) subordinate in the AUTOSAR specification.

Hereinafter, the update control device 11 as an example of the first embodiment, the update control device 12 as an example of the second embodiment, and the write control device 13 as an example of the third embodiment will be described. As described above, since the “write control device” is a concept including the “update control device”, the first and second embodiments are embodiments of the “update control device”, and the first to third embodiments are embodiments of the “write control device”.

### First Embodiment

### (Configuration of Update Control Device 11)

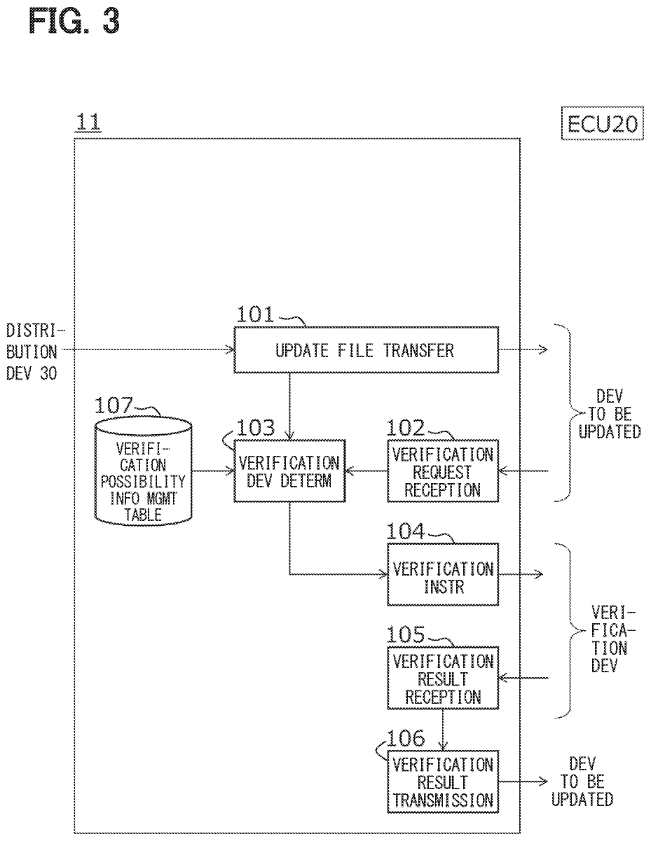

With reference to FIG. 3, a configuration example of the update control device 11 of the embodiment will be described. The update control device 11 has an update file transfer unit 101, a verification request reception unit 102, a verification device determination unit 103, a verification instruction unit 104, a verification result reception unit 105, a verification result transmission unit 106, and a verification possibility information management table storage unit 107. In the embodiment, it is assumed that the update control device 11 is provided for the integration ECU 20a in FIG. 2.

The update file transfer unit 101 (corresponding to a “file transfer unit” or an “update file transfer unit”) obtains an update file (corresponding to a “file” or “update file”) for updating software (corresponding to “information” or “software”) and a “signature generated from an update file” from the distribution device 30, and transmits the update file to a device to be updated (corresponding to a “device to be written” or “device to be updated”). In the embodiment, in addition to an update file, a signature is also transmitted to a device to be updated. Further, a software updating instruction may be transmitted to the device to be updated. A “signature generated from an update file” includes not only a signature generated directly from an update file but also a signature generated indirectly from an update file, and a signature generated from information specifying an update file, for example, like a hash value of an update file.

As illustrated in FIG. 1A and FIG. 1B, in the case where the update control device 11 is mounted in a mobile body, the update file transfer unit 101 obtains an update file from a server device or the like provided on the outside of the electronic control system S via a wireless communication or a wired communication and transmits the update file to a device to be updated among the ECUs 20 via an in-vehicle communication network. As illustrated in FIG. 1C, in the case of realizing the update control device 11 by a server device or the like on the outside of the vehicle, the update control device 11 obtains an update file generated by the server device or generated by another device, and transmits the update file to the device to be updated among the ECUs 20 constructing the electronic control system S via the wireless communication or wired communication.

The update file obtained by the update file transfer unit 101 includes an update file for updating software mounted in a device to be updated. The update file may be an update file group including a plurality of update files for updating a plurality of pieces of software. An update file group may include update files respectively corresponding to a plurality of devices to be updated. Alternatively, an update file may be files obtained by dividing a single update file into a plurality of update files.

An update file may include information specifying a device to be updated in which software to be updated is mounted, and information indicating a data amount of each of update files. The information may be stored in the header of an update file or an update data part of an update file.

A signature may include information indicating the size of the signature, a key used for the signature, and a scheme of the signature. The information may be stored in the header of the signature.

A key used for generating a signature in the distribution device 30 may be an arbitrary key. Since a signature can be verified by using a verification device having high processing performance in the embodiment as will be described later, it is desirable to use post-quantum cryptography (hereinafter, abbreviated as PQC). For example, multivariable public key cryptography can be mentioned. Concretely, CRYSTAL-Dilithium, FALCON, and SPHINCS+ as standard PQC selected by the National Institute of Standards and Technology of the United States of America in July 2022 can be mentioned.

The verification request reception unit 102 receives a verification request as a request for verifying a signature from a device to be updated. In the embodiment, it is assumed that a verification request includes a signature scheme and information specifying a signature scheme. Since a signature scheme can be specified by using an update file or a signature obtained by the update file transfer unit 101, a verification request may be only a request for a signature verifying process, a flag, or the like. A method of generating a verification request by a device to be updated will be described in the article of the configuration of a device to be updated.

The verification device determination unit 103 determines a verification device which verifies a signature. In the embodiment, when the verification request reception unit 102 receives a verification request, a verification device is determined on the basis of a verification possibility information management table which will be described next. In the embodiment, a verification device is determined from the ECUs 20 constructing the electronic control system S. The verification device determination unit 103 may determine a verification device for verifying a signature from the plurality of ECUs 20 on the basis of a signature scheme. A verification device may be the same ECU as the ECU 20 realizing the update control device 11. A verification device may exclude the ECU 20 realizing the update control device 11. A verification device may be a device on the outside of the electronic control system S.

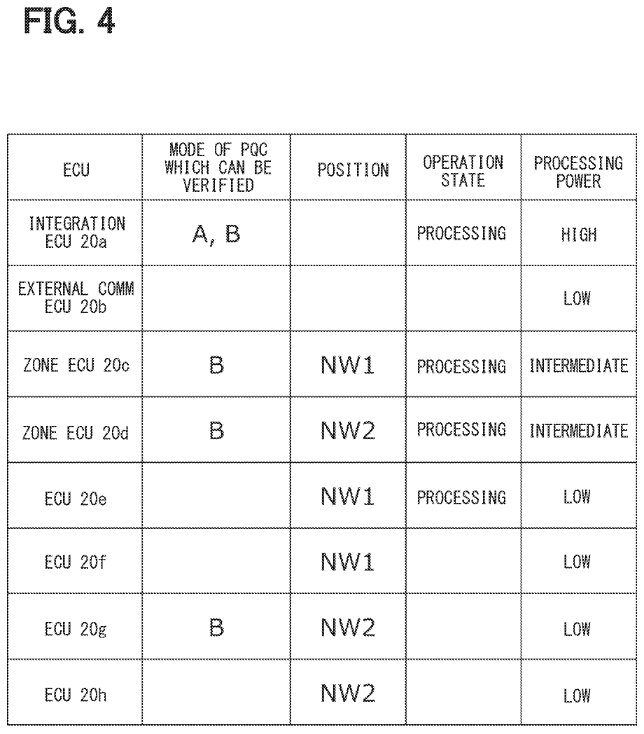

Referring to FIG. 4, the content of the verification possibility information management table will be described. In the verification possibility information management table, for each of the ECUs 20 constructing the electronic control system S, verification possibility information as “information indicating whether verification of a signature can be performed or not” is recorded. The verification possibility information management table is stored in the verification possibility information management table storage unit 107. The “information indicating whether verification of a signature can be performed or not” includes not only information directly indicating whether verification of a signature can be performed or not but also information indirectly indicating whether verification of a signature can be performed or not such as resources of each of the ECUs.

In FIG. 4, as the information indicating whether verification of a signature can be performed or not, a mode of PQC capable of verifying a signature is recorded. For example, the integration ECU 20a can perform verification by modes A and B. The zone ECUs 20c and 20d and the individual ECU 20g can perform verification by only the mode B. The other ECUs do not have any verification modes capable of performing verification.

In FIG. 4, as the information indicating whether verification of a signature can be performed or not, furthermore, the position in the electronic control system, an operation state, and processing power are recorded. The position in the electronic control system is, for example, information specifying a network connected. The operation state is, for example, information whether a signature verifying process and other processes are being performed or not. The information indicating the operation state is updated every predetermined time. The processing power indicates, for example, the resources of each of the ECUs 20 and is a value or sign determined as a total evaluation of the processing speed of the CPU, the capacity and access speed of the RAM, the bandwidth of I/O, a network protocol, and the like.

In the embodiment, the verification device determination unit 103 determines an ECU 20 capable of performing verification as a verification device on the basis of the signature mode included in a verification request received by the verification request reception unit 102 and the verification possibility information management table read from the verification possibility information management table storage unit 107. For example, in the case where information indicating the mode A is included in a verification request, the verification device determination unit 103 determines the integration ECU 20a as a verification device. In the case where information indicating the mode B is included in a verification request, the verification device determination unit 103 determines any of the integration ECU 20a, the zone ECU 20c, the zone ECU 20d, and the individual ECU 20g as a verification device.

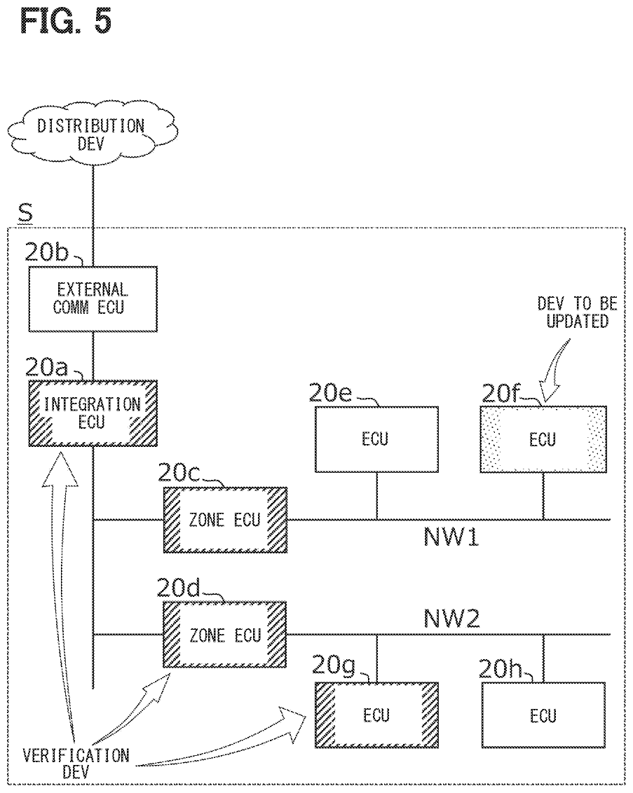

Referring to FIG. 5, a method of determining a verification device will be described. A case is assumed that candidates of a verification device are the integration ECU 20a, the zone ECU 20c, the zone ECU 20d, and the individual ECU 20g, and a device to be updated is the individual ECU 20f. For example, in the case where the verification device determination unit 103 performs adoption on the basis of a device closest to the position of the device to be updated, the zone ECU 20c which is provided for the same network as the individual ECU 20f and is a higher-order ECU is determined as a verification device. In the case where the verification device determination unit 103 performs adoption on the basis of a device having highest processing power, the integration ECU 20a having the highest processing power is determined as a verification device. In the case where the verification device determination unit 103 performs adoption on the basis of a device which is not currently performing process, the individual ECU 20g which is not performing process is determined as a verification device. The verification device determination unit 103 may determine a verification device using a plurality of bases.

The verification instruction unit 104 “transmits” a signature and a verification instruction instructing verification of the signature to the verification device determined by the verification device determination unit 103. The verification instruction unit 104 also transmits information necessary for verification of a signature such as an update file and information specifying an update file such as a hash value generated from the update file. The expression “transmits” includes not only the case of output to a communication network but also the case of transfer of information within an update control device when a verification device as a destination of transmission is realized on the same hardware as the update control device.

The verification result reception unit 105 receives a verification result as a result of the signature verification from the verification device. The verification result transmission unit 106 transmits the verification result received by the verification result reception unit 105 to the device to be updated.

The verification result may be directly transmitted from the verification device to the device to be updated. For example, the verification instruction transmitted from the verification instruction unit 104 may include an instruction to transmit a verification result to a device to be updated. In this case, the verification result reception unit 105 and the verification result transmission unit 106 are unnecessary.

### (Configuration of Device to be Updated)

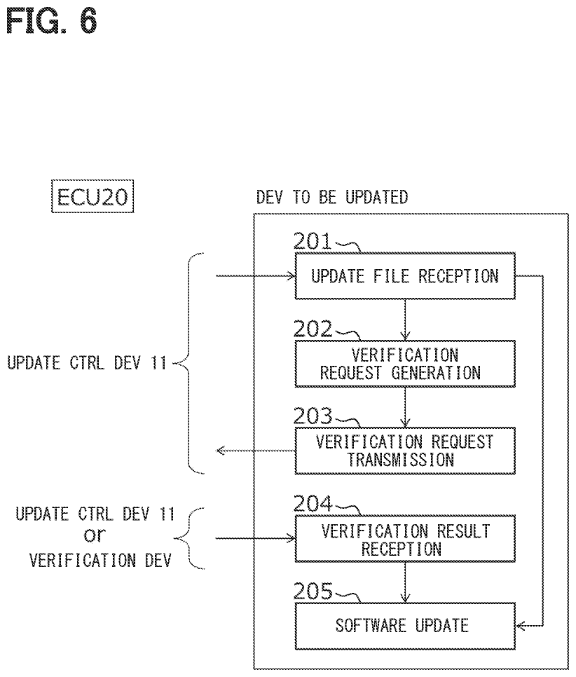

With reference to FIG. 6, a configuration example of the device to be updated of the embodiment will be described. A device to be updated (corresponding to a “device to be written” or a “device to be updated”) has an update file reception unit 201, a verification request generation unit 202, a verification request transmission unit 203, a verification result reception unit 204, and a software update unit 205.

The update file reception unit 201 receives an update file from the update control device 11. In the embodiment, an update file and, in addition, a signature generated from the update file are received. Further, a software updating instruction may be received from the update control device 11.

The verification request generation unit 202 specifies a signature scheme from the signature or the update file received by the update file reception unit 201 and, based on the signature scheme, generates a verification request as a request to verify the signature. For example, the verification request generation unit 202 specifies a signature scheme from information indicating a key used for the signature and a signature scheme included in the signature, a data amount of the update file included in the update file, or another information, and determines whether or not the device to be updated itself can perform signature verification by the signature scheme. In the case where the signature verification can be performed, the device to be updated itself verifies the signature and updates software on the basis of the verification result. In the case where the signature verification cannot be performed, a verification request as a request to verify a signature is generated. A verification request may include a signature scheme or information specifying a signature scheme.

The verification request transmission unit 203 transmits the verification request generated by the verification request generation unit 202 to the update control device 11.

The verification result reception unit 204 receives a verification result to the verification request transmitted from the verification request transmission unit 203. The verification result is received from the update control device 11 as a device which transmits the verification result or the verification device.

The software update unit 205 updates software by using the update file received by the update file reception unit 201 on the basis of the verification result received by the verification result reception unit 204. Concretely, in the case where the verification result indicates success in the verification, updating of software is executed in accordance with the software update instruction. In the case where the verification result indicates failure in the verification, updating of software is interrupted.

### (Operation of Update Control Device 11)

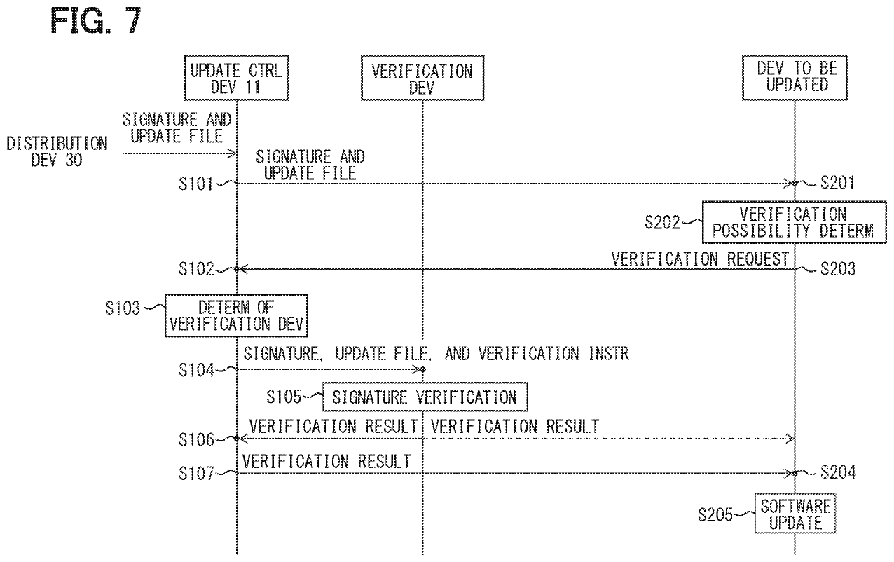

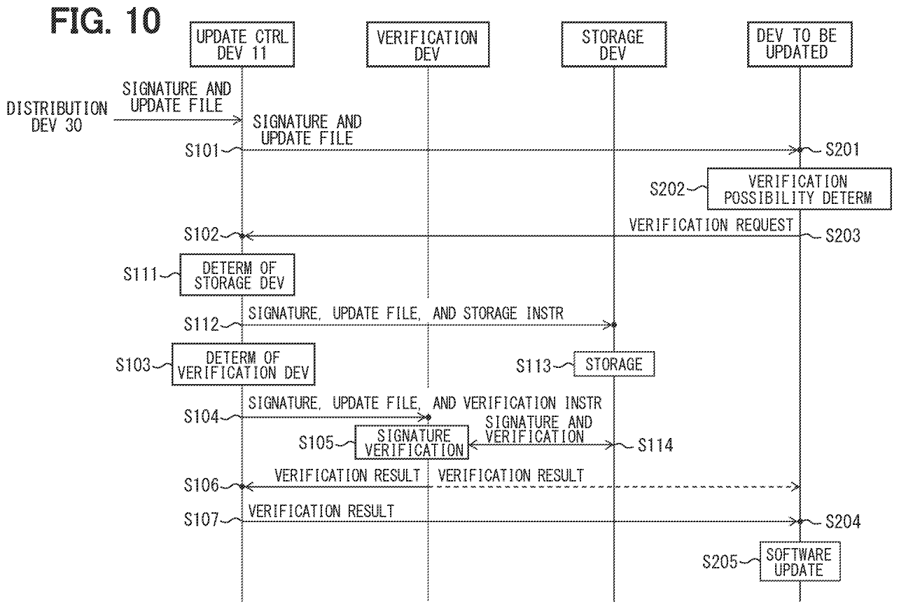

Referring to FIG. 7, the operation of the entire electronic control system S of the embodiment including the update control device 11 will be described. The operation illustrated in FIG. 7 indicates not only an update control method executed by the update control device 11 but also the procedure of an update control program which can be executed by the update control device 11. The processes to be described are not limited to the order illustrated in FIG. 7. In other words, as long as there is no restriction such that a certain step has a relation to use a result of a preceding step, the order may be changed. Similarly, the order may be changed in FIGS. 10, 13, and 15 which will be described later.

The update file transfer unit 101 of the update control device 11 obtains an update file for updating software and a signature generated from the update file from the distribution device 30, and transmits the signature and the update file to the device to be updated (S101).

The update file reception unit 201 of the device to be updated receives the signature and the update file from the update control device 11 (S201). The verification request generation unit 202 specifies the signature scheme from the signature or the update file received in S201, and determines whether the device to be updated itself can verify the signature by the signature scheme or not (S202). In the case where the signature verification can be performed, the device to be updated itself verifies the signature and updates software on the basis of the verification result (S205). In the case where the signature verification cannot be performed, a verification request as a request for verifying a signature is generated, and the verification request transmission unit 203 transmits the verification request to the update control device 11 (S203).

The verification request reception unit 102 of the update control device 11 receives the verification request from the device to be updated (S102). In the case where the verification request is received in S102, the verification device determination unit 103 reads the verification possibility information management table from the verification possibility information management table storage unit 107, and determines a verification device on the basis of the verification possibility information management table (S103). The verification instruction unit 104 transmits the signature, the update file, and the verification instruction to the verification device (S104).

The verification device receives the signature, the update file, and the verification instruction from the update control device 11, and verifies the signature by using an open key held by itself on the basis of the verification instruction (S105). The verification device transmits the verification result to the update control device 11. In the case where an instruction to transmit a verification result to the device to be updated is included in the verification instruction, the verification device transmits the verification result to the device to be updated.

The verification result reception unit 105 of the update control device 11 receives the verification result from the verification device (S106). The verification result transmission unit 106 transmits the verification result received in S106 to the device to be updated (S107).

The verification result reception unit 204 of the device to be updated receives the verification result from the update control device 11 or the verification device (S204). The software update unit 205 updates software on the basis of the verification result received in S204 (S205).

As described above, according to the embodiment, since the update control device 11 determines a verification device when a verification request is received, it is sufficient to determine a verification device only in the case where a device to be updated cannot verify a signature. It is unnecessary to determine a verification device for all of signatures transmitted from the distribution device 30, so that the burden on the update control device 11 can be lessened. In addition, the update control device 11 of the embodiment can, for example, select a device to be verified which is adapted to verification of a signature on the basis of a verification possibility information management table. Consequently, in a situation that a plurality of ECUs 20 are ready for PQC but all of ECUs 20 are not ready for PQC, that is, in a transition period of migration from an existing cryptography to the PQC, an optimum device to be verified can be selected and the PQC verification can be performed. Furthermore, a plurality of PQC verifications can be allocated to a plurality of verification devices, so that the burden on a specific verification device can be prevented from being increased.

### (Modification of Update Control Device 11)

In the first embodiment, in the case where signature verification in a device to be updated cannot be performed, the update control device 11 determines a verification device, and verification of a signature is performed by the verification device. Since key data length of PQC is longer than that of any of existing cryptographies, a sufficient storage area is necessary. However, there is a case that a verification device does not always have a sufficient storage area. The update control device 11 of the modification has, in addition to the configuration of the first embodiment, a configuration of determining a storage device for storing a signature and an update file and storing a signature and an update file in the storage device. Hereinafter, the configuration different from that of the first embodiment will be described. For the configuration common to that of the first embodiment, the description of the first embodiment is to be cited and will not be repeated.

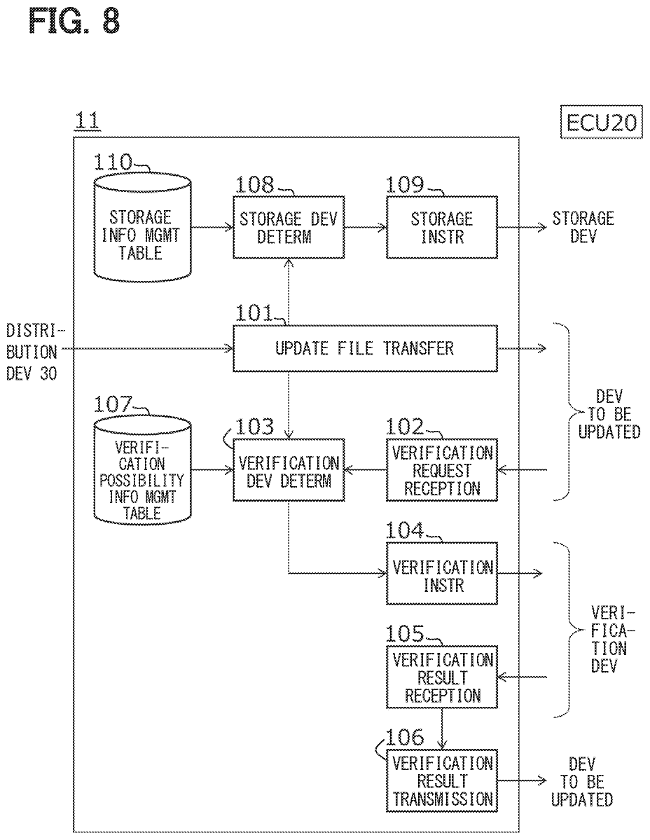

With reference to FIG. 8, a configuration example of the update control device 11 of the present modification will be described. The update control device 11 of the modification has, in addition to the configuration of the update control device 11 of the first embodiment, a storage device determination unit 108, a storage instruction unit 109, and a storage unit information management table storage unit 110.

The storage device determination unit 108 determines a storage device to which a signature and an update file are stored on the basis of a storage unit information management table to be subsequently described.

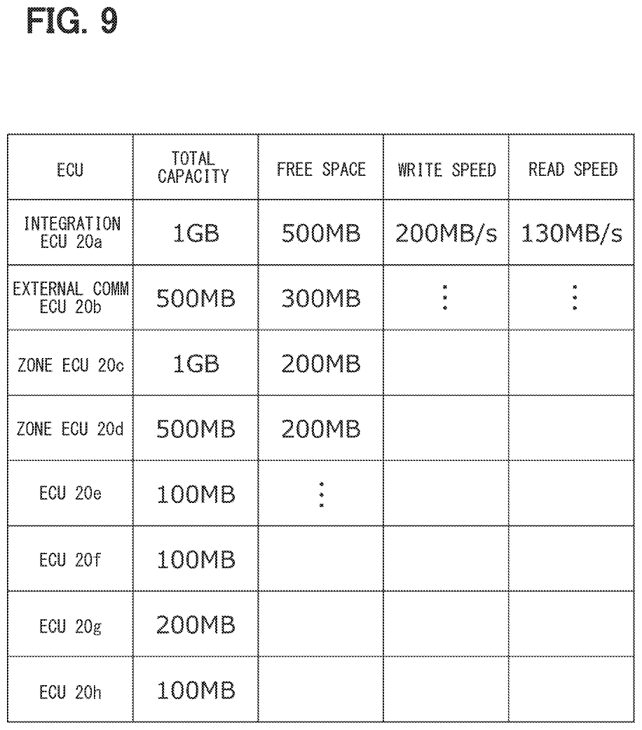

Referring to FIG. 9, the content of the storage unit information management table will be described. The storage unit information management table records storage unit information as “information indicating a state of a storage unit” of each of the ECUs 20 constructing the electronic control system S. The storage unit information management table is stored in the storage unit information management table storage unit 110. “Information indicating a state of a storage unit” is information related to a storage unit itself and operation of the storage unit. For example, the capacity of a storage unit, a free space of the storage unit, write speed of the storage unit, read speed of the storage unit, transfer speed from the storage unit, and the like are included.

In FIG. 9, as the storage unit information, total capacity of a storage as the storage unit is recorded. For example, the integration ECU 20a has capacity of 1 GB. In FIG. 9, as the storage unit information, further, free space, write speed, and read speed are recorded. The free space is updated every predetermined time. In addition, seek time, access time, the number of platters, rotational speed, the kind of interface, and capacity of a cache memory may be recorded.

In the modification, the storage device determination unit 108 determines an ECU 20 capable of storing a signature and an update file as a storage device on the basis of the size of a signature and an update file received by the update file transfer unit 101 and a storage unit information management table read from the storage unit information management table storage unit 110. For example, an ECU 20 having a storage in which a file having the size of a signature and an update file can be stored and the free space is equal to or larger than a predetermined ratio in the total capacity is determined as a storage device. A storage device may be the same ECU as the ECU 20 realizing the update control device 11. A storage device may exclude the ECU 20 realizing the update control device 11. The storage device may be a device on the outside of the electronic control system S.

A criterion to determine a storage device by the storage device determination unit 108 is not limited to the above. For example, a storage device may be determined from storages whose write speed and read speed are equal to or higher than a predetermined speed.

Further, the storage device determination unit 108 may determine a storage device on the basis of the distribution method of an update file from the distribution device 30. For example, in the case of the download method, a storage device having capacity of a storage to which a signature and an update file can be downloaded in a lump is selected. For example, in the case of the streaming method, the capacity of the storage may be smaller than that in the case of the download method. For example, in the case of the pseudo-streaming method, the capacity of the storage may be smaller than that in the case of the download method. However, since transfer operation is frequently necessary, a storage device having a device of low latency is selected.

The storage unit information management table and the verification possibility information management table may be provided as a single table.

The storage instruction unit 109 “transmits” a signature, an update file, and a storage instruction to instruct storage of the update file to the storage device. The storage instruction may include information specifying a verification device and an instruction to output a signature and an update file to a verification device when there is a request from the verification device. The expression “transmit” includes, in addition to the case of output to a communication network, the case of transferring a process of information in the update control device when a storage device as a transmission destination is realized on the same hardware as the update control device.

Since the configuration of a device to be updated is the same as that of the first embodiment, the description of the first embodiment and FIG. 6 are to be cited and repetitive description will not be given.

Referring to FIG. 10, the operation of the entire electronic control system S as the modification of the first embodiment including the update control device 11 will be described. Steps in FIG. 10 which are the same as those of FIG. 7 have the same step numbers, and the description of the first embodiment is to be cited.

The storage device determination unit 108 of the update control device 11 reads a storage unit information management table from the storage unit information management table storage unit 110 and determines a storage device on the basis of the storage unit information management table (S111). The storage instruction unit 109 transmits the signature, the update file, and the storage instruction to the storage device (S112).

The storage device receives the signature, the update file, and the storage instruction from the update control device 11 and stores the signature and the update file into the storage unit on the basis of the storage instruction (S113). When there is a request from a verification device or an instruction from an update control device 11, the storage device outputs the signature and the update file stored in the storage unit to the verification device (S114).

As described above, according to the modification, since the update control device 11 determines a storage device in addition to a verification device, even in the case where the verification device does not have a sufficient storage area, verification in the verification device can be performed. Since the update control device 11 of the modification determines a storage device on the basis of the distribution method of an update file from the distribution device 30, a proper storage device can be determined in consideration of the characteristics of the distribution method.

### Second Embodiment

### (Configuration of Update Control Device 12)

In the first embodiment, when a verification request from a device to be updated is received, the update control device 11 determines a verification device. In a second embodiment, regardless of a verification request from a device to be updated, the update control device 12 determines a verification device.

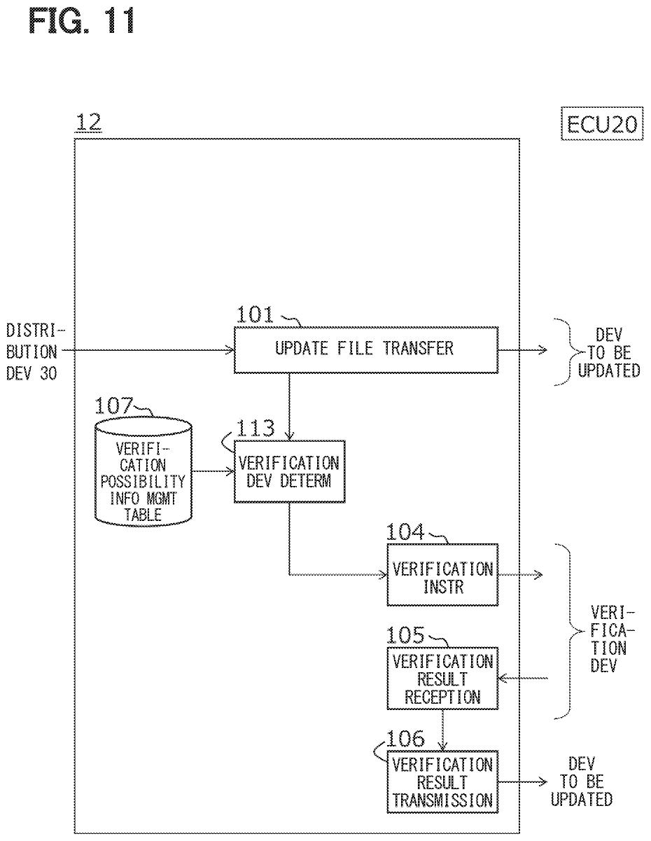

With reference to FIG. 11, a configuration example of the update control device 12 of the embodiment will be described. Different from the configuration of the update control device 11 of the first embodiment, the update control device 12 of the second embodiment does not have the verification request reception unit 102. The operation of the verification device determination unit 113 is also different. The same numbers as those of the blocks of the first embodiment are designated to blocks having functions common to those of the blocks of the first embodiment, and the description of the first embodiment will be cited.

The verification device determination unit 113 determines a verification device for verifying a signature. In the embodiment, the update file transfer unit 101 specifies the signature scheme from the signature or the update file obtained from the distribution device 30, and determines a verification device on the basis of the signature scheme. For example, the signature scheme is specified from information indicating a key used for the signature and the signature scheme included in the signature, a data amount of an update file included in the update file, or other information. On the basis of the verification possibility information management table, whether the device to be updated can verify the signature by the signature scheme or not is determined. When it is determined that a device to be updated can verify a signature, determination of a verification device is not performed. When it is determined that a device to be updated cannot verify a signature, determination of a verification device is performed.

### (Configuration of Device to be Updated)

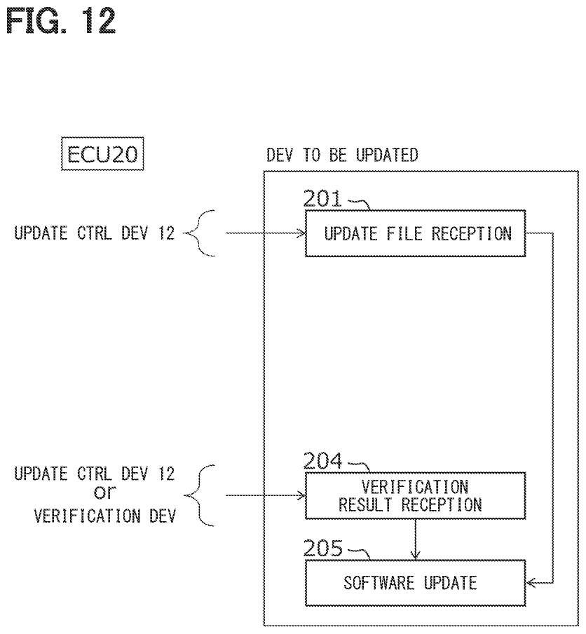

With reference to FIG. 12, a configuration example of the device to be updated of the embodiment will be described. The device to be updated of the embodiment does not have the verification request generation unit 202 and the verification request transmission unit 203 different from the device to be updated of the first embodiment illustrated in FIG. 6. Since the other configuration is the same as the configuration of the first embodiment, the description of the first embodiment is to be cited. In the case where a device to be updated of the embodiment does not verify a signature, the update file reception unit 201 may not receive a signature but may receive only an update file from the update control device 12.

### (Operation of Update Control Device 12)

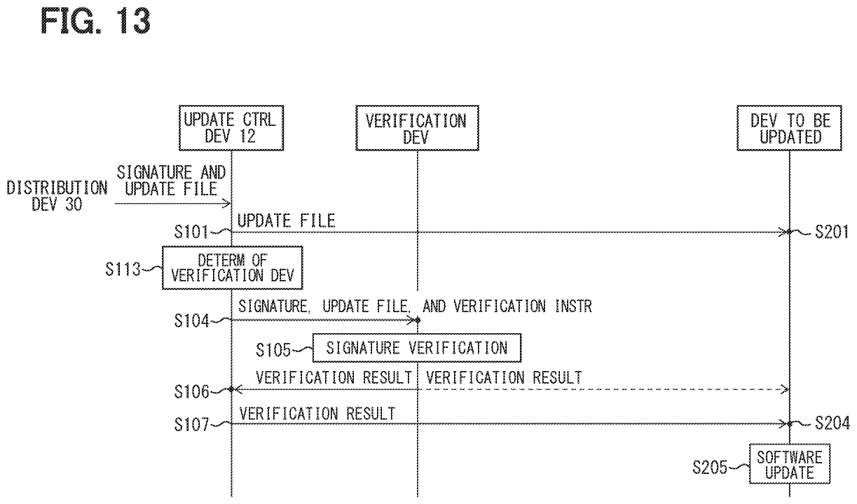

Referring to FIG. 13, the operation of the entire electronic control system S of the embodiment including the update control device 12 will be described. The same step numbers are designated to steps in FIG. 13 which are the same as those of FIG. 7, and the description of the first embodiment is to be cited.

The verification device determination unit 113 of the update control device 12 specifies a signature scheme from a signature or an update file obtained from the distribution device 30 in S101, and determines a verification device on the basis of the signature scheme (S113).

As described above, according to the embodiment, the update control device 12 specifies a signature scheme from a signature or an update file received from the distribution device 30, and determines a verification device on the basis of the signature scheme. Consequently, the verification device determination process can be performed within the update control device 12, and determination of a verification device can be unified. In addition, the update control device 12 of the embodiment can, for example, select a device to be verified which is adapted to verification of a signature on the basis of a verification possibility information management table. Consequently, in a situation that a plurality of ECUs 20 are ready for PQC but all of ECUs 20 are not ready for PQC, that is, in a transition period of migration from an existing cryptography to the PQC, an optimum device to be verified can be selected and the PQC verification can be performed. Furthermore, a plurality of PQC verifications can be allocated to a plurality of verification devices, so that the burden on a specific verification device can be prevented from being increased.

### (Modification of Update Control Device 12)

In a manner similar to the modification of the first embodiment, the present embodiment may also have a configuration of determining a storage device. The update control device 12 of the modification has, in addition to the configuration of the second embodiment, a configuration of determining a storage device for storing a signature and an update file and storing a signature and an update file in the storage device.

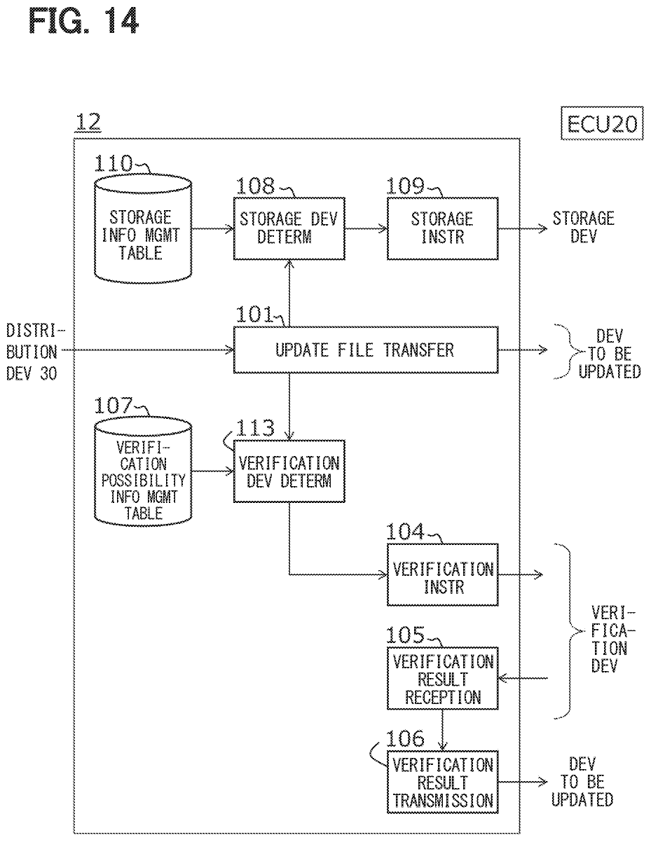

FIG. 14 is a diagram illustrating a configuration example of the update control device 12 of the present modification. The update control device 12 of the modification has, in addition to the configuration of the update control device 12 of the second embodiment, the storage device determination unit 108, the storage instruction unit 109, and the storage unit information management table storage unit 110. Since the configuration is the same as that of the modification of the first embodiment, the description of the modification of the first embodiment is to be cited.

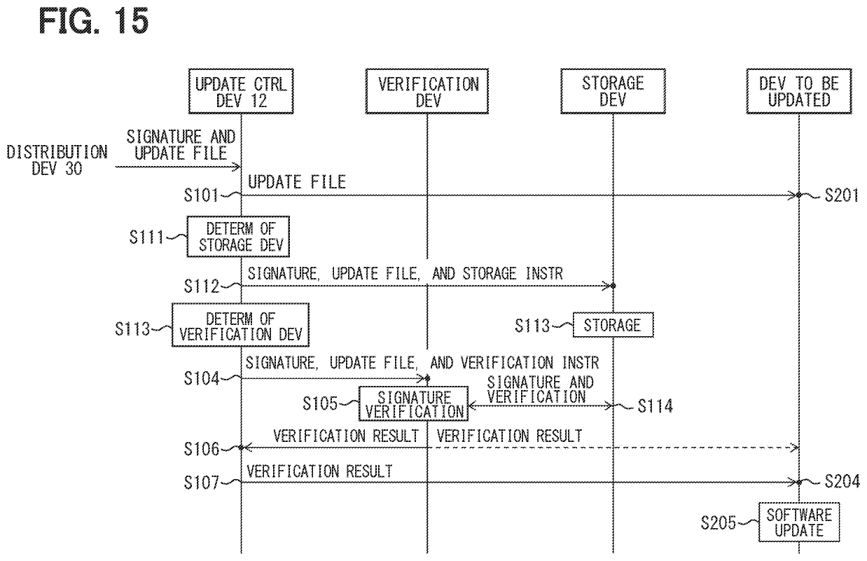

FIG. 15 is a diagram illustrating the operation of the entire electronic control system S as a modification of the embodiment including the update control device 12. The same step numbers are designated to steps in FIG. 15 which are the same as the steps in FIG. 13, and the description of the first embodiment is to be cited through the second embodiment. The same step numbers are designated to steps which are the same as those in FIG. 10, and the description of the modification of the first embodiment is to be cited.

As described above, according to the modification, since the update control device 12 determines a storage device in addition to a verification device, even in the case where the verification device does not have a sufficient storage area, verification in the verification device can be performed.

### Third Embodiment

### (Configuration of Update Control Device 13)

In the first and second embodiments, an update file is obtained for updating software. In a third embodiment, software and various data are obtained regardless of the purpose of updating software.

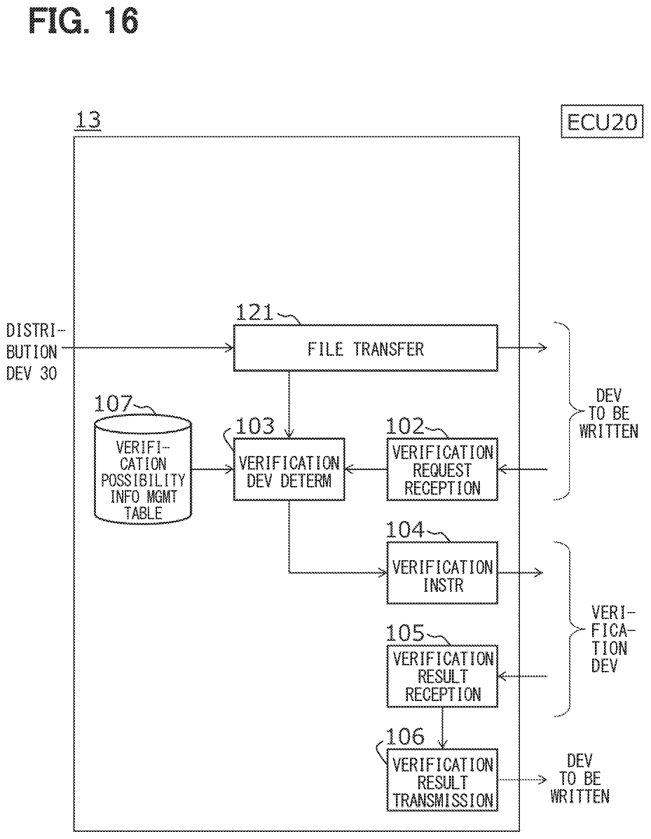

With reference to FIG. 16, a configuration example of the write control device 13 of the embodiment will be described. Different from the configuration of the update control device 11 of the first embodiment, the write control device 13 has the file transfer unit 121 in place of the update file transfer unit 101. The same numbers as those of the blocks of the first embodiment are designated to blocks having functions common to those of the blocks of the first embodiment, and the description of the first embodiment will be cited.

The file transfer unit 121 (corresponding to a “file transfer unit”) obtains a file (corresponding to a “file”) for writing software and various data (corresponding to “information”) and a “signature generated from a file” from the distribution device 30, and transmits the file to a device to be written (corresponding to “a device to be written”). A “signature generated from a file” includes not only a signature generated directly from a file but also a signature generated indirectly from a file, for example, a signature generated from information specifying a file such as a hash value of the file.

A file obtained by the file transfer unit 121 is not limited to software to be updated but may be software for other uses and various data. Examples are image data such as a moving image and a stational image, map data, route data, an attack determination table used for determination of a cyberattack, and the like.

### (Configuration of Device to be Written)

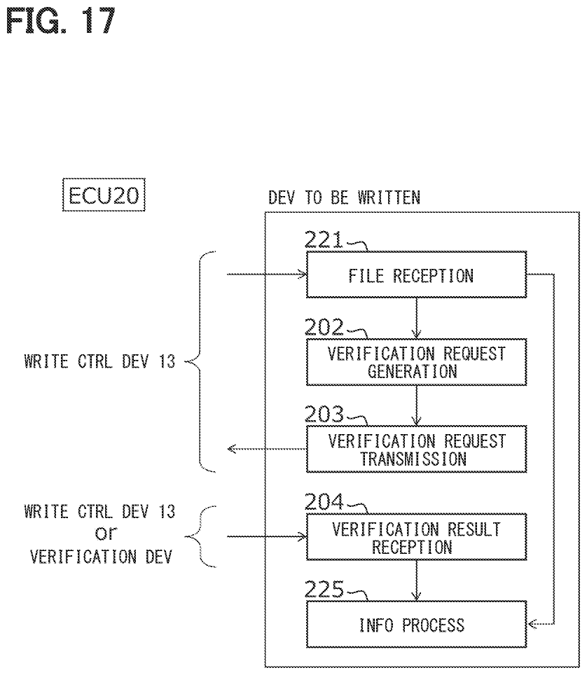

With reference to FIG. 17, a configuration example of the device to be written of the embodiment will be described. A device to be written (corresponding to a “device to be written”) has, different from the device to be updated in the first embodiment, a file reception unit 221 in place of the update file reception unit 201 and an information process unit 225 in place of the software update unit 205. The same numbers as those of the blocks of the first embodiment are designated to blocks having functions common to those of the blocks of the first embodiment, and the description of the first embodiment will be cited.

The file reception unit 221 receives a file from the write control device 13. Examples of the file are as described above.

The information process unit 225 executes a process according to the purpose of software or various data included in a file by using the file received by the file reception unit 221 on the basis of a verification result received by the verification result reception unit 204. For example, the information process unit 225 executes software, performs verification using image data, installs map data, guides along route data, or determines a cyberattack by using an attack determination table.

### (Operation of Write Control Device)

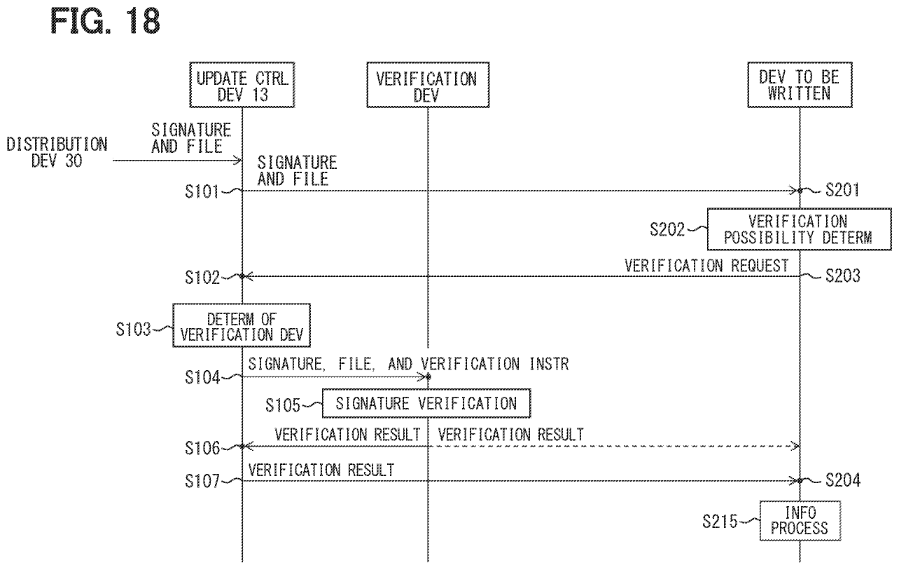

Referring to FIG. 18, the operation of the entire electronic control system S of the embodiment including the write control device 13 will be described. The same step numbers are designated to steps in FIG. 18 which are the same as those in FIG. 7, and the description of the first embodiment is to be cited.

The information process unit 225 of the device to be written executes a process according to the purpose of the software or various data included in the file by using the file obtained from the write control device 13 in S201 (S215).

### (Others)

The third embodiment can be applied to not only the first embodiment but also the modification of the first embodiment, the second embodiment, and the modification of the second embodiment. In this case, “update” and “software” described in the first and second embodiments are properly replaced by “write” and “software or various data”, respectively.

### Fourth Embodiment

In the first and second embodiments, the update control device 11 or 12 determines a verification device. On the other hand, in a fourth embodiment, when an ECU 20 which receives a verification request of a device to be updated can verify a signature, the ECU 20 verifies a signature. When the ECU 20 cannot verify a signature, the verification request is transferred to another ECU 20.

A device to be updated of the fourth embodiment is the same as that of the first embodiment illustrated in FIG. 6. That is, the update file reception unit 201 receives a signature and an update file from the update control device 11. The verification request generation unit 202 specifies a signature scheme from the signature or the update file received by the update file reception unit 201, and generates a verification request as a request to verify a signature on the basis of the signature scheme. The verification request transmission unit 203 transmits the verification request generated by the verification request generation unit 202 to a higher-order ECU 20.

For example, in FIG. 2, when the individual ECU 20f is a device to be updated, the individual ECU 20f transmits a verification request to the zone ECU 20c, and the zone ECU 20c receives it. In the case where signature verification can be performed by the zone ECU 20c, the zone ECU 20c verifies a signature, and transmits a verification result to the individual ECU 20f. In the case where signature verification cannot be performed by the zone ECU 20c, the verification request generated by the individual ECU 20f is transferred to the integration ECU 20a as a higher-order ECU 20. The integration ECU 20a which received the verification request verifies the signature, and transmits a verification result to the individual ECU 20f.

With the configuration, the update control devices 11 and 12 do not have to manage verification of a signature, and verification of PQC can be performed with a simple configuration.

The characteristics of the write control device, the update control device, and the like in each of the embodiments of the present disclosure have been described above.

Since each of the terms used in the embodiments is an example, it may be replaced by a synonymous term or a term including a synonymous function.

In the block diagrams used for explaining the embodiments, the components of devices are classified and organized by functions. A block indicating its function is realized by an arbitrary combination of hardware or software. Since the functions are illustrated, the block diagrams can be also grasped as disclosure of the disclosure of a method and the disclosure of a program realizing the method.

With respect to the function blocks which can be grasped as the processes, the flows, and the methods described in the embodiments, the order may be changed unless there is a limitation such as a relation that a step uses a result of a preceding step.

The terms of first, second, and the Nth (N is an integer) used in the embodiments and the scope of disclosures are used to distinguish two or more configurations and methods of the same kind, and do not limit the orders and superiority or inferiority.

The premise of the update control device of each of the embodiments is a device for controlling updating of an electronic control unit as a component of an in-vehicle system mounted in a vehicle. However, the update control device of the present disclosure is applied to a device controlling updating of an arbitrary electronic control unit unless otherwise limited in the scope of disclosures. The premise of the write control device of each of the embodiments is a device for controlling writing to an electronic control unit as a component of an in-vehicle system mounted in a vehicle. However, the write control device of the present disclosure is applied to a device controlling writing to an arbitrary electronic control unit unless otherwise limited in the scope of disclosures.

Examples of forms of the devices of the present disclosure are as follows. Forms of parts include a semiconductor element, an electronic circuit, a module, and a microcomputer. Forms of half-finished products include an electric control unit (ECU) and a system board. Forms of finished products include a cellphone, a smartphone, a tablet, a personal computer (PC), a workstation, and a server. Moreover, devices having a communication function, for example, a video camera, a still camera, and a car navigation system are included.

Necessary functions such as an antenna and a communication interface may be added to each of the devices.

In addition, the present disclosure can be realized not only by dedicated hardware having the configurations and functions described in the embodiments but also by a combination of a program for realizing the present disclosure, which is recorded on a recording medium such as a memory or a hard disk, and general-purpose hardware having a dedicated or general-purpose CPU capable of executing the program, a memory, and the like.

A program stored in a non-transitory tangible recording medium of dedicated or general-purpose hardware (for example, an external storage device (hard disk, USB memory, CD/BD, or the like) or an internal storage device (RAM, ROM, or the like) can be provided from a server to dedicated or general-purpose hardware via a recording medium or via a communication line without a recording medium. In such a manner, the latest functions can be always provided through upgrading of a program.

In the present disclosure, the write control device and the update control device for an in-vehicle electronic control unit which is mainly mounted on an automobile have been described. However, the present disclosure can be applied to all of mobile objects such as a motorcycle, a vessel, a train, an aircraft, and the like. The present disclosure is not limited to a mobile object but can be applied to all of products each including a microcomputer. Although the objective of the present disclosure is verification of a signature, it may be decryption of a message encrypted by Post-Quantum Cryptography. Although the objective of the present disclosure is a signature between a distribution device and a device to be updated, it may be a signature between devices in an electronic control unit, for example, between an update control device and a device to be updated.

What is claimed is:

1. An update control device controlling updating of software of a device to be updated as a software update target among a plurality of electronic control units which are connected to the update control device, the update control device comprising:
an update file transfer unit that is configured to obtain an update file for updating the software and a signature generated from the update file from a distribution device, and transmit the update file to the device to be updated;
a verification device determination unit that is configured to determine a verification device verifying the signature from the plurality of electronic control units on a basis of a scheme of the signature; and
a verification instruction unit that is configured to transmit the signature and a verification instruction instructing verification of the signature to the verification device.

2. The update control device according to claim 1, wherein
the update file transfer unit transmits the signature and the update file to the device to be updated,
the update control device further comprises
a verification request reception unit receiving a verification request as a request to verify the signature transmitted from the device to be updated,
wherein
when the verification request reception unit receives the verification request, the verification device determination unit determines the verification device.

3. The update control device according to claim 1, wherein
the verification device determination unit specifies the scheme of the signature from the signature or the update file, and determines the verification device on a basis of the scheme of the signature.

4. The update control device according to claim 2, further comprising
a verification possibility information management table storage unit in which verification possibility information as information indicating whether or not the signature can be verified is recorded for each of the plurality of electronic control units,
wherein
the verification device determination unit determines the verification device on a basis of the verification possibility information management table.

5. The update control device according to claim 2, wherein
the verification instruction unit includes, in the verification instruction, an instruction to transmit a verification result as a result of verification of the signature to the device to be updated.

6. The update control device according to claim 2, further comprising:
a verification result reception unit receiving a verification result as a result of verification of the signature from the verification device; and
a verification result transmission unit transmitting the verification result to the device to be updated.

7. The update control device according to claim 2, further comprising:
a storage unit information management table storage unit in which storage unit information as information indicating a state of a storage unit in each of the plurality of electronic control units is recorded;
a storage device determination unit determining a storage device as a destination of storage of the signature and the update file on a basis of the storage unit information management table; and
a storage instruction unit transmitting the signature, the update file, and a storage instruction instructing storage of the update file to the storage device.

8. The update control device according to claim 7, wherein
the storage device determination unit determines the storage device on a basis of a distribution method of the update file from the distribution device.

9. The update control device according to claim 2, wherein
the update file is an update file group including a plurality of pieces of the software for a plurality of devices to be updated, respectively.

10. The update control device according to claim 2, wherein
the update control device is mounted together with the electronic control unit in a movable object.

11. The update control device according to claim 2, wherein
the electronic control unit is mounted in a movable object, and
the update control device is disposed outside the movable object.

12. An electronic control system comprising:
an update control device controlling updating of software of a device to be updated as a software update target among a plurality of electronic control units which are connected; and
the plurality of electronic control units,
wherein
the update control device comprises:
an update file transfer unit obtaining an update file for updating the software and a signature generated from the update file from a distribution device, and transmitting the update file to the device to be updated;
a verification device determination unit determining a verification device verifying the signature from the plurality of electronic control units on a basis of a scheme of the signature; and
a verification instruction unit transmitting the signature and a verification instruction instructing verification of the signature to the verification device, and
the device to be updated comprises:
an update file reception unit receiving the update file from the update control device;
a verification result reception unit receiving a verification result of the signature from the verification device or the update control device; and
a software update unit updating software by using the update file on a basis of the verification result.

13. The electronic control system according to claim 12, wherein
the update file transfer unit of the update control device transmits the signature and the update file to the device to be updated, and
the device to be updated further comprises:
a verification request generation unit specifying the scheme of the signature from the signature or the update file, and generating a verification request as a request to verify the signature on a basis of the scheme of the signature; and
a verification request transmission unit transmitting the verification request to the update control device.

14. A write control device controlling writing of information to a device to be written as an object to which information is to be written among a plurality of electronic control units which are connected, comprising:
a file transfer unit obtaining a file for writing the information and a signature generated from the file from a distribution device, and transmitting the file to the device to be written;
a verification device determination unit determining a verification device verifying the signature from the plurality of electronic control units on a basis of a scheme of the signature; and
a verification instruction unit transmitting the signature and a verification instruction instructing verification of the signature to the verification device.

15. A software update control method executed by an update control device controlling updating of software in a device to be updated as a software update target among a plurality of electronic control units which are connected, comprising:
obtaining an update file for updating the software and a signature generated from the update file from a distribution device, and transmitting the update file to the device to be updated;
determining a verification device verifying the signature from the plurality of electronic control units on a basis of a scheme of the signature; and
transmitting the signature and a verification instruction instructing verification of the signature to the verification device.

16. A non-transitory computer-readable storage medium storing a software update control program which can be executed by an update control device controlling updating of software of a device to be updated as a software update target among a plurality of electronic control units which are connected, comprising:
obtaining an update file for updating the software and a signature generated from the update file from a distribution device, and transmitting the update file to the device to be updated;
determining a verification device verifying the signature from the plurality of electronic control units on a basis of a scheme of the signature; and
transmitting the signature and a verification instruction instructing verification of the signature to the verification device.
